(19) United States
(12) Patent Application Publication
(10) Pub. No.: US 2025/0010227 A1
(43) Pub. Date: Jan. 9, 2025

(54) Fuel Water Separator for Operation Under Vacuum

(71) Applicant: Cummins Filtration Inc., Nashville, TN (US)

(72) Inventors: Mark T. Wieczorek, Cookeville, TN (US); Ted S. Loftis, Cookeville, TN (US); Joshua Ryan Hendrixson, Smithville, TN (US)

(73) Assignee: Cummins Filtration Inc., Nashville, TN (US)

(21) Appl. No.: 18/887,500

(22) Filed: Sep. 17, 2024

Related U.S. Application Data
(63) Continuation of application No. PCT/US2023/015089, filed on Mar. 13, 2023.
(60) Provisional application No. 63/321,143, filed on Mar. 18, 2022.

(51) Int. Cl. B01D 36/00; B01D 29/21; B01D 29/54

(52) U.S. Cl. CPC B01D 36/003; B01D 29/21; B01D 29/54; B01D 2201/302

(57) ABSTRACT

Systems and methods for a fuel water separator for operation under a vacuum are described herein. The fuel water separator includes a filter cartridge. The filter cartridge includes a filter element having a first filter media and a second filter media positioned downstream the first filter media. The filter cartridge also includes a first vent positioned at a filter element first end and structured to allow air to pass therethrough. The filter cartridge also includes a second vent positioned at the filter element first end and structured to allow the air to pass therethrough.

### CROSS-REFERENCE TO RELATED CASES

This application is a continuation of PCT Application No. PCT/US2023/015089, filed Mar. 13, 2023, which claims the benefit of U.S. Provisional Application No. 63/321,143, filed Mar. 18, 2022, entitled FUEL WATER SEPARATOR FOR OPERATION UNDER VACUUM. The contents of these applications are incorporated herein by reference in their entirety for all purposes.

### FIELD

The present application relates generally to fuel water separator assemblies for use in supplying filtered fuel to downstream devices.

### BACKGROUND

Fuel water separator assemblies may be used to separate water from fuel to protect downstream devices from corrosion. Fuel water separator assemblies may further protect downstream devices by including filter elements to separate impurities from the fuel that may damage the downstream devices. However, in some fuel water separator assemblies, one or more filter media layers may trap air within the fuel water separator assembly, which may reduce water removal performance.

### SUMMARY

An example embodiment relates to filter cartridge. The filter cartridge includes a filter element. The filter element includes a first filter media structured to filter fuel, and a second filter media positioned downstream the first filter media and structured to filter the fuel. The filter cartridge also includes a first vent positioned at a filter element first end and structured to allow air to pass therethrough. The filter cartridge also includes a second vent positioned at the filter element first end and structured to allow the air to pass therethrough.

Another example embodiment relates to a filtration system. The filtration system includes a filter head and a filter cartridge. The filter head has an inlet for receiving a fuel and an outlet for providing filtered fuel. The filter cartridge is coupled to the filter head. The filter cartridge includes a filter element having a first filter media structured to filter the fuel. The filter cartridge also includes a first vent positioned at a filter element first end and structured to allow air to pass therethrough. The outlet is positioned at a suction side of a pump.

Another example embodiment relates to a filter element. The filter element includes a first filter media, a second filter media, a first endplate, and an inner body. The first filter media is structured to filter fuel. The second filter media is positioned downstream of the first filter media. The second filter media is structured to filter the fuel. The first endplate is coupled to the first filter media. The first endplate has a first vent formed therethrough. The first vent enables a fluid to flow from an upstream side of the first filter media to an upstream side of the second filter media thereby bypassing the first filter media. The inner body is coupled to the first endplate and is coupled to the second filter media. The inner body has a second vent formed therethrough. The second vent enables the fluid to bypass the second filter media.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1A is a perspective view of a fuel water separator assembly, according to an example embodiment.

FIG. 1B is a perspective view of an example filter element shown in a disassembled state for use in the fuel water assembly of FIG. 1A.

FIG. 1C is a side sectional view showing a portion of the filter element of FIG. 1B shown in an assembled state.

FIG. 2A is a detailed side view showing aspects of the fuel water separator of FIG. 1A.

FIG. 2B is a detailed side view showing aspects of the fuel water separator of FIG. 1A.

FIG. 3 is a top sectional view of a filter element for the fuel water separator assembly of FIG. 1A.

FIG. 4A is a side view of a filter element for the fuel water separator assembly of FIG. 1A.

FIG. 4B is a top view of a filter media for the fuel water separator assembly of FIG. 1A.

FIG. 4C is a detailed section view of the filter media of FIG. 4A, according to a first example embodiment.

FIG. 4D is a detailed section view of the filter media of FIG. 4A, according to a second example embodiment.

FIG. 4E is a detailed section view of the filter media of FIG. 4A, according to a third example embodiment.

FIG. 5A is a side sectional view of a fuel water separator assembly, to an example embodiment.

FIG. 5B is a top sectional view of a filter element, according to an example embodiment.

FIGS. 6A-6C are top sectional views of a filter element, according to various example embodiments.

FIG. 7 is a side sectional view of a filter element, according to an example embodiment.

### DETAILED DESCRIPTION

Referring to the Figures generally, various embodiments disclosed herein relate to a filtration system including a fuel water separator assembly for operation under vacuum. That is, an outlet of the fuel water separator assembly is positioned at a vacuum (e.g., suction) side of a pump.

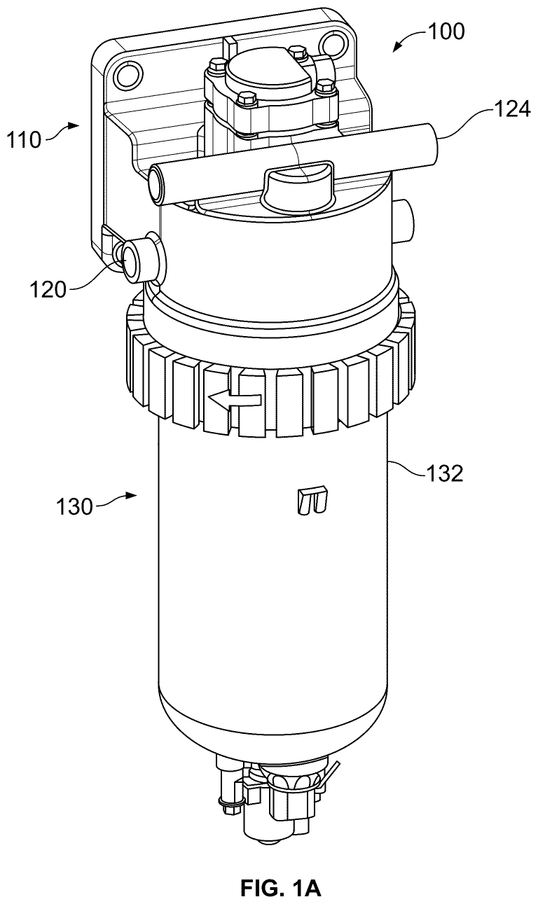

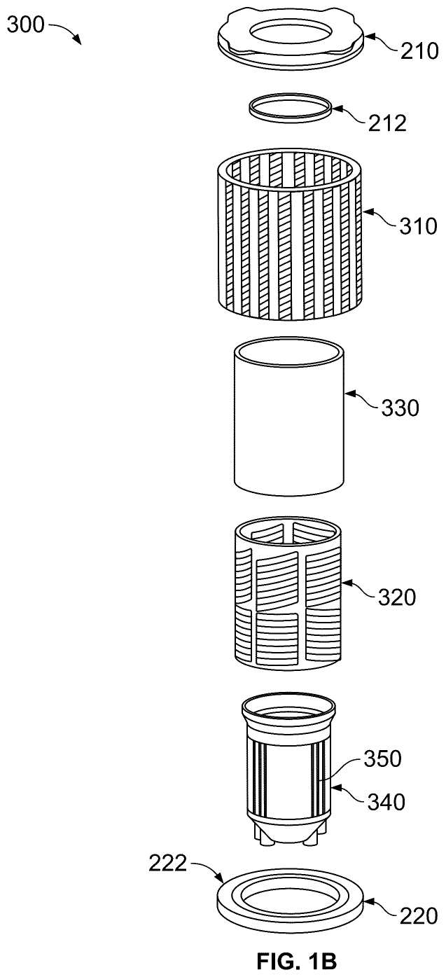

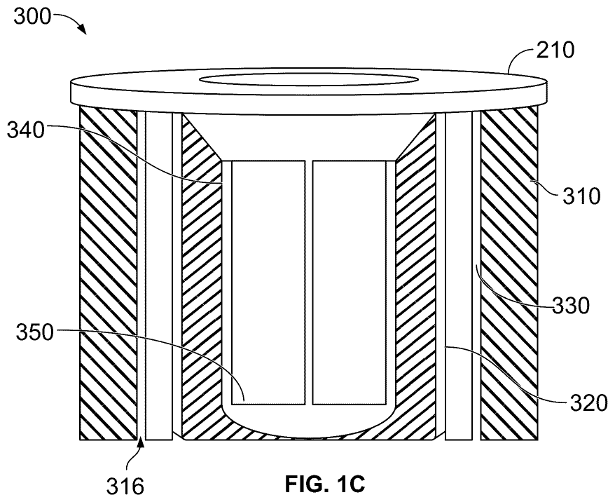

Referring generally to FIGS. 1A-5B, embodiments shown and described in further detail herein below relate to an outside-in flow design for a fuel water separator assembly. It should be understood that the embodiments described herein may be utilized in other fuel water separator arrangements. For example, the embodiments described herein may be utilized in an inside-out flow design and/or any other type of fuel water separator. Additionally, the fuel water separator assembly, including the filter element, may include more or fewer components than as shown in the Figures. Accordingly, references to various components being within, downstream, exterior, upstream, and the like are relative to the embodiments shown in Figures, and it should be understood that other embodiments, such as an inside-out flow design for a fuel water separator, may have the same or similar components provided in a different arrangement.

FIG. 1A is a perspective view of a fuel water separator assembly 100, according to an example embodiment. The fuel water separator assembly 100 is configured to provide filtered fuel to a downstream device such as an engine. As shown, the fuel water separator assembly includes a filter head 110 having at least one inlet 120 and at least one outlet 124 and a filter cartridge 130. The filter cartridge 130 includes a shell 132 that defines an internal volume. It should be understood that the fuel water separator assembly 100 may include more or fewer components than as shown in FIG. 1A. The filter cartridge 130 also includes a filter element 300, shown in FIG. 1B

FIG. 1B is a perspective view of a filter element 300 shown in a disassembled state for the fuel water separator assembly 100 of FIG. 1A. The filter element 300 is configured to filter the fuel (e.g., by removing contaminants) and separate water from the fuel. In some embodiments, the filter element 300 is removably coupled to the shell 132. In other embodiments, the filter element 300 is permanently secured within the shell 132 such that the filter element 300 cannot be removed from the shell 132 without causing damage to the filter element 300 and/or the shell 132. The filter element 300 is at least partially contained within the shell 132 and/or the filter head 110.

As shown, the filter element 300 includes a first filter media 310, a center tube 320, a second filter media 350, an inner body 340, and a third filter media 330. The filter element 300 is also shown to include a first endplate 210, a first sealing member 212 (e.g., an O-ring, a gasket, etc.), and a second endplate 220 having a second sealing member 222.

The first filter media 310 is positioned between and is coupled to the first endplate 210 and the second endplate 220. The first filter media 310 is formed in a cylindrical or annular configuration. The first filter media 310 may be pleated to increase surface area. The first filter media 310 may be a single-layer media or a multi-layer media made from at least one of a woven fiber, a non-woven material, a wet laid material, a polymeric material, a glass material, a cellulose material, and/or other suitable material. The first filter media 310 is structured to allow the unfiltered fuel to be filtered by flowing through the first filter media 310. For example, the unfiltered fuel flows through the first filter media 310, and the first filter media 310 removes impurities such as particulates, organic matter, and the like, from the unfiltered fuel as the unfiltered fuel passes through the first filter media 310. The impurities are trapped by the first filter media 310. The first filter media 310 may also at least partially separate water from the unfiltered fuel.

The first endplate 210 and the second endplate 220 are fixedly coupled to the first filter media 310. In some embodiments, the center tube 320 and the inner body 340 are positioned between the first endplate 210 and the second endplate 220. In some embodiments, the center tube 320 and/or the inner body 340 is/are fixedly coupled the first endplate 210 and the second endplate 220. The first endplate 210 and the second endplate 220 facilitate coupling the filter element to the shell 132. As shown, the filter element 300 includes a first sealing member 212 and a second sealing member 222. In some embodiments, the filter element 300 includes more or fewer sealing members. The sealing members (e.g., first sealing member 212 and second sealing member 222) are structured to form a fluid tight seal between the components of the filter element 300 (e.g., the first endplate 210, the second endplate 220, the center tube 320, and/or the inner body 340) and/or form a fluid tight seal between one of the components of the filter element 300 and another component of the fuel water separator assembly 100 (e.g., the shell 132). For example, when the filter element is positioned within the shell 132, the first endplate 210 and/or the second endplate 220 locate the first sealing member 212 and second scaling member 222, respectively, within the shell 132 such that a fluid tight seal is formed between the endplate the first endplate 210 and/or the second endplate 220 and the shell 132. In some embodiments, when the fuel water separator assembly 100 has an outside-in flow configuration, the endplates (210, 220) and sealing members thereof (212, 222) are positioned to direct the fluid flow into the first filter media. For example, the second sealing member 222 forms a second seal between the second endplate 220 and the shell 132. The second seal separates an area between the at least one inlet 120 and the filter media (e.g., the first filter media 310, the second filter media 350, and/or the third filter media 330) from a fluid collection area (e.g., a water sump) thereby forcing the unfiltered/unseparated fuel to flow through the filter media. In some embodiments, the second seal is a second radial seal. In other embodiments, the fuel water separator assembly 100 has an inside-out flow configuration, the second sealing member 222 may be omitted.

The center tube 320 is positioned within the first filter media 310. The center tube 320 is a hollow tube that defines an inner volume. The center tube 320 includes one or more holes through the tube wall that allow the fuel to pass through. In some embodiments, the center tube 320 is fixedly coupled to the first endplate 210, the second endplate 220, and/or the first filter media 310. In other embodiments, the center tube 320 is positioned within the first filter media 310 without coupling to the first filter media 310. In these embodiments, the center tube 320 may contact the first filter media 310 during operation. For example, the first filter media 310 may flex or deflect inwards, towards the center tube 320. In some embodiments, the center tube 320 is retained between the first endplate 210 and the second endplate 220 with or without coupling to the first endplate 210 and/or the second endplate 220. According to various embodiments, the third filter media 330 may be fixedly coupled to the center tube 320, wrapped around the center tube 320, and/or positioned within the center tube 320 such that the center tube 320 supports the third filter media 330. In some embodiments, the third filter media 330 may contact the first filter media 310 when the third filter media 330 is wrapped around the center tube 320. In some embodiments, when the third filter media 330 is fixedly coupled to the center tube 320, the center tube 320 and the third filter media 330 are molded together such that the center tube 320 and the third filter media 330 form a single, unitary piece. In some embodiments, the third filter media 330 is fixedly coupled to the first endplate 210 and/or the second endplate 220 such that the fuel passes through the third filter media 330 before passing through the one or more holes. In some embodiments, the center tube 320 extends in an axial direction away from the third filter media 330 such that at least a portion of the center tube 320 is not covered by the third filter media 330. The portion of the center tube 320 does not include the one or more holes such that the fuel cannot pass through the portion of the center tube 320. In some embodiments, and as described herein below, the center tube 320 and/or the third filter media 330 is an optional component of the filter element 300.

As briefly described above, the third filter media 330 is wrapped around an exterior (e.g., radially outward) portion of the center tube 320. The third filter media 330 is positioned such that the fuel flowing out of the first filter media 310 flows through the third filter media 330. The third filter media 330 is structured to remove water from fuel that passes through the third filter media 330 by coalescence. In some embodiments, the third filter media 330 is a coalescing tube made from a woven fiber, a non-woven material, a felt, a semi-permeable membrane, and/or any other suitable material for coalescing water. For example, a filtered (by the first filter media 310) and un-separated fuel-water mixture flows through the third filter media 330, and the water coalesces on the third filter media 330 thereby separating the water from the fuel.

The inner body 340 is positioned within the center tube 320. The inner body 340 is a hollow tube having a closed end and an open end and defining an inner volume. The inner body 340 includes one or more holes through the inner body 340 that allow the fuel to pass through. The inner body 340 is fixedly coupled to the first endplate 210 and/or the second endplate 220. The inner body 340 is fixedly coupled to the second filter media 350 such that the fuel also passes through the second filter media 350. In some embodiments, the inner body 340 extends in an axial direction away from the second filter media 350 such that at least a portion of the inner body 340 is not covered by the second filter media 350. The portion of the inner body 340 does not include the one or more holes such that the fuel cannot pass through the portion of the inner body 340.

As briefly described above, the second filter media 350 is coupled to the inner body 340. Specifically, the second filter media 350 is positioned within the one or more holes of the inner body 340 such that the fuel flowing through the one or more holes is filtered by the second filter media 350. The second filter media 350 is positioned such that the fuel flowing out of the third filter media 330 flows through the second filter media 350. The second filter media 350 is structured to remove water from fuel that passes through the second filter media 350. The second filter media 350 is a hydrophobic screen made from a woven, hydrophobic material, and/or any other suitable material for separating water from fuel. For example, a filtered (by the first filter media 310) and at least partially separated fuel-water mixture flows through the second filter media 350, and the water is prevented from flowing through the hydrophobic material of the second filter media 350 thereby further separating the water from the fuel. In some embodiments and described herein below, the second filter media 350 and the third filter media 330 are combined into a single filter media. In these embodiments the combined second filter media 350 and third filter media 330 is made of a combination of woven and non-woven materials suitable for the second filter media 350 and the third filter media 330. For example, the combined second filter media 350 and third filter media 330 may be a perforated layer coalescer. The perforated layer coalescer is a filter media having an unpleated coalescing layer that includes one or more perforations therethrough.

FIG. 1C is a side sectional view showing a portion of the filter element 300 of FIG. 1B shown in an assembled state. The filter element 300 is substantially cylindrical in shape and defines an axial direction (e.g., up and down as shown in FIG. 1C) and a radial direction (e.g., left to right as shown in FIG. 1C). As shown, the first filter media 310 is coupled to the first endplate 210 at a first filter media first end. The third filter media 330 is positioned radially inwards from the first filter media 310 (e.g., downstream). The third filter media 330 surrounds the center tube 320. The inner body 340 is positioned radially inward from the center tube 320. The second filter media 350 is coupled to the inner body 340 and radially inward (e.g., downstream) from the third filter media 330 and the center tube 320.

As shown in FIG. 1C, a gap 316 is formed between the first filter media 310 and the third filter media 330. The gap 316 is formed by an outer diameter of the third filter media 330 being a predetermined length shorter than an inner diameter of the first filter media 310. The gap 316 substantially prevents air that enters the filter element 300 from becoming trapped between the first filter media 310 and the third filter media 330. For example, air is able to flow in the gap 316, between the first filter media 310 and the third filter media 330, in an axial and/or a circumferential direction. The gap 316 allows air to freely move to the location of a third air vent 332, avoiding entrapment between the first filter media 310 and the third filter media 330. In other embodiments, the filter element 300 does not include a gap 316 such that the first filter media 310 contacts the third filter media 330.

As briefly described above, in alternative and/or additional embodiments, the arrangement of the components of the filter element 300 may be different than as shown in FIG. 1C. In one example embodiment, the third filter media 330 is positioned radially outwards from the first filter media 310. Additionally and/or alternatively, the second filter media 350 is positioned radially outward from the first filter media 310 and/or the third filter media 330. In yet another example embodiment, the second filter media 350 and the third filter media 330 are unitarily combined into a single filter media and/or replaced by a single filter media. It should be understood that any of the embodiments described herein are not mutually exclusive and accordingly may be combined in various combinations, unless otherwise noted.

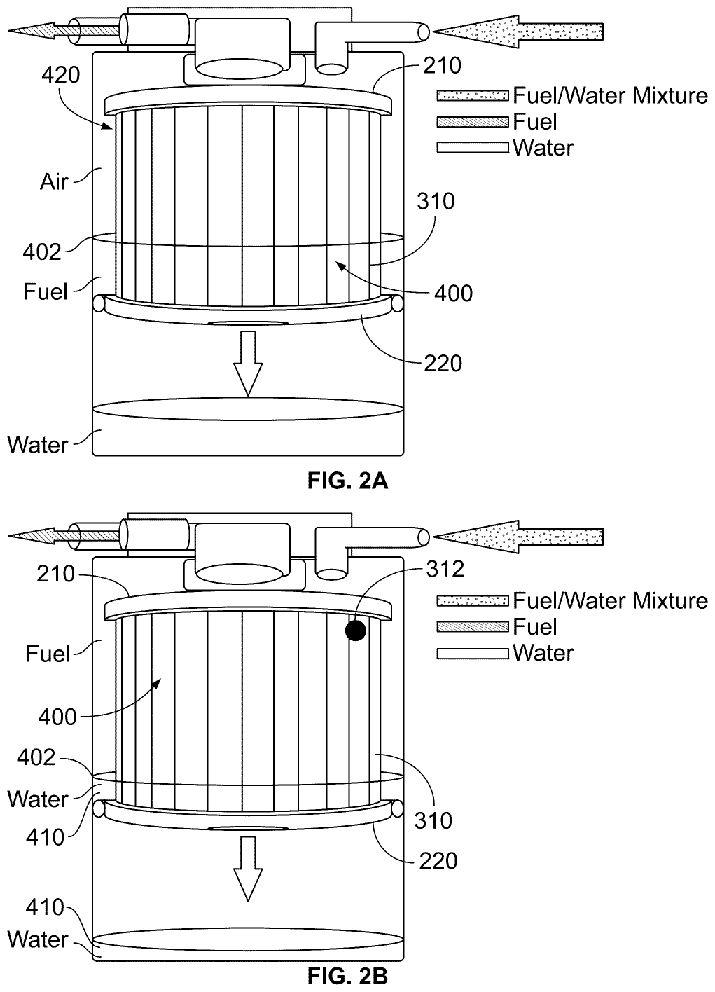

FIGS. 2A and 2B are detailed side views showing aspects of the fuel water separator assembly 100 of FIG. 1A, according to various example embodiments. As shown in FIG. 2B, the fuel water separator assembly 100 includes one or more air venting features described in further detail herein below. The fuel water separator assembly 100 shown in FIG. 2A is shown before adding any air venting features (e.g., without air venting features).

FIG. 2A is a detailed side view showing aspects of the fuel water separator assembly 100 of FIG. 1A. The fuel water separator assembly 100 is shown in operation (e.g., coupled to a vacuum/suction side of a pump and with the shell 132 shown as transparent. An unfiltered fuel 400 is shown upstream (e.g., radially outward) from the first filter media 310. The fuel level 402 within the fuel water separator assembly 100 covers a bottom portion of an exterior surface of the first filter media 310. Air 420 is trapped upstream of the first filter media 310 and covers the remaining surface (e.g., a top portion) of the first filter media 310.

FIG. 2B is a detailed side view showing aspects of the fuel water separator assembly 100 of FIG. 1A. The fuel water separator assembly 100 is shown in operation (e.g., coupled to a vacuum/suction side of a pump and with the shell 132 shown as transparent. An unfiltered fuel 400 is shown upstream (e.g., radially outward) from the first filter media 310. The fuel level 402 within the fuel water separator assembly 100 covers a large top portion of the exterior surface of the first filter media 310. Water 410 that is separated from the fuel covers a smaller bottom portion of the exterior of the first filter media 310 (e.g., because water 410 is denser than fuel 400). The air 420 is no longer trapped upstream of the first filter media 310, as air can pass through the first air vent 312, allowing the fuel level to rise.

Referring generally to FIGS. 2A and 2B, when the fuel 400 is filtered by the first filter media 310, the second filter media 350, and/or the third filter media 330, air is separated from the fuel 400 (e.g., by the first filter media 310, the second filter media 350, and/or the third filter media 330). For example, because the air 420 cannot easily pass through the first filter media 310, the second filter media 350, and/or the third filter media 330, the air 420 becomes trapped upstream of the first filter media 310, the second filter media 350, and/or the third filter media 330. Due to the trapped air 420 on the surface of the first filter media 310, the second filter media 350, and/or the third filter media 330, the fuel 400 has a smaller surface area to pass through the first filter media 310, the second filter media 350, and/or the third filter media 330. Accordingly, the velocity of the fuel 400 through the first filter media 310, the second filter media 350, and/or the third filter media 330 must increase to maintain a volume flow rate of fuel 400 to a downstream component (e.g., an engine). The increased flow velocity reduces water removal performance of the first filter media 310, the second filter media 350, and/or the third filter media 330. Despite the more open pore structure and higher flow velocity of the second filter media 350 and/or the third filter media 330, air is trapped upstream of the second filter media 350 and/or the third filter media 330, in addition to being trapped upstream of the first filter media 310. The air vents described herein solve the problem of air becoming trapped upstream of filter media such that water removal performance is improved by decreasing the flow velocity through the filter media.

The addition of one or more air venting features allows the air to flow downstream of the first filter media 310, the second filter media 350, and/or the third filter media 330. Accordingly, the fuel 400 fills into the fuel water separator assembly 100 and covers a larger portion of the first filter media 310, the second filter media 350, and/or the third filter media 330. When the fuel 400 covers a larger surface area of the first filter media 310, the second filter media 350, and/or the third filter media 330 the filtering performance is improved. For example, when the fuel 400 covers a larger surface area of the second filter media 350, a flow velocity through the second filter media 350 (e.g., a face velocity) is lowered thereby increasing filtration performance.

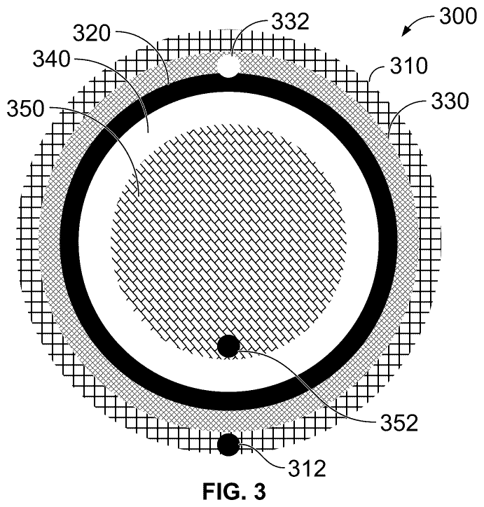

FIG. 3 is a top sectional view of a filter element 300 for the fuel water separator assembly of FIG. 1A. As shown in FIG. 3, the filter element 300 includes the first filter media 310, the center tube 320, the third filter media 330, the inner body 340, and the second filter media 350. As shown in FIG. 3, the filter element 300 is for an outside-in flow design for a fuel water separator assembly 100. As described above, in alternative embodiments, the arrangement of the components of the filter element 300 is different (e.g., for an inside-out flow design).

A first air vent 312 is formed through the first filter media 310 (e.g., between an upstream side and a downstream side of the first filter media 310). The first air vent 312 allows air 420 to pass therethrough such that the air 420 is not trapped by the first filter media 310. The first air vent 312 allows the air 420 to bypass the first filter media 310.

A second air vent 352 is formed through the second filter media 350 (e.g., between an upstream side and a downstream side of the second filter media 350). The second air vent 352 allows air 420 to pass therethrough such that the air 420 is not trapped by the second filter media 350. The second air vent 352 allows air 420 to bypass the second filter media 350.

A third air vent 332 is formed through the third filter media 330 (e.g., between an upstream side and a downstream side of the third filter media 330). The third air vent 332 allows air 420 to pass therethrough such that the air 420 is not trapped by the third filter media 330. The third air vent 332 allows air 420 to bypass the third filter media 330. In some embodiments, the filter element 300 may include more, fewer, or different filter media. In these embodiments, one or more of the filter media included in the filter element 300 includes an air vent formed through the filter media.

In the embodiment shown in FIG. 3, the first air vent 312 is disposed at a first filter media first side (e.g., bottom), the second air vent 352 is disposed at a second filter media first side (e.g., bottom), and the third air vent 332 is disposed at a third filter media second side (e.g., top). In this embodiment, the air vents (312, 332, 352) are disposed at diametrically opposing sides of the filter media (310, 330, 350), relative to the nearest upstream air vent (312, 332, 352). The position of the air vents (312, 332, 352) advantageously reduces the amount of contaminants that bypass the filter media (310, 330, 350) via the air vents (312, 332, 352) because, for example, the contaminants cannot easily flow in a circumferential direction (e.g., around a perimeter of the filter media (310, 330, 350). In other embodiments, the air vents (312, 332, 352) are positioned at different radial sides of the filter media (310, 330, 350). For example, the air vents (312, 332, 352) may be formed at the same side (e.g., a top side, a bottom side, a right side, etc.), or at a predetermined angle relative to the nearest upstream air vent (e.g., between 0° and 180°).

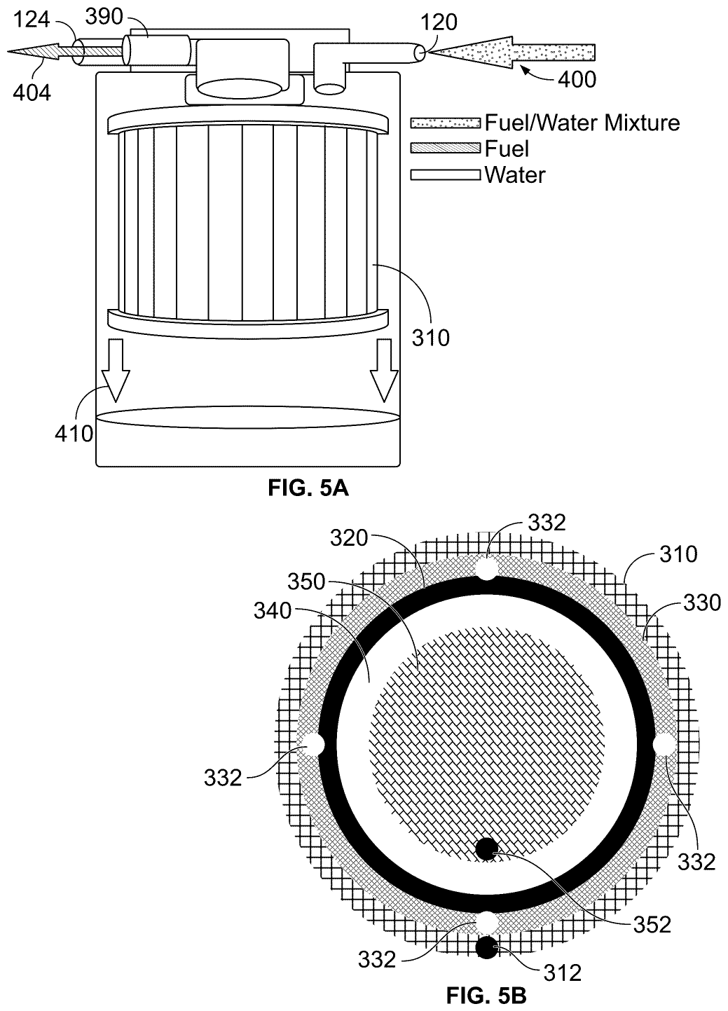

In yet other embodiments, the air vents (312, 332, 352) are positioned at various axial positions along an axial length of the corresponding filter media (310, 330, 350). For example, the air vents (312, 332, 352) may be positioned at various axial positions between a filter element first end (e.g., proximate the first endplate 210) and a filter element second end (e.g., proximate the second endplate 220). In an example embodiment, the air vents (312, 332, 352) are positioned proximate a gravitational top of the filter element 300 such that buoyancy causes air or other gases to move towards the gravitational top of the filter element 300, proximate the air vents (312, 332, 352). In some embodiments, the size and number of air vents (312, 332, 352) may be different. In some embodiments, the filter element 300 may include one or more first air vents 312, one or more second air vents 352, and/or one or more third air vents 332. For example, the filter element 300 may include a plurality of third air vents 332, as described herein with respect to FIG. 5B. In these embodiments, the one or more first, second, or third air vents (312, 352, 332), advantageously provide additional paths for air to flow through the filter media (310, 330, 350), such that at least one of the one or more first, second or third air vents (312, 352, 332) is positioned at a gravitational top of the filter element 300 even if the filter element 300 is not oriented in a vertical manner (e.g., if the filter is tilted). Accordingly, the filter element 300 may include air vents (312, 332, 352) varying in quantity, size, and/or location such that the filter element 300 advantageously allows for air venting through the filter media (310, 330, 350) while minimizing the amount of contaminants bypassing the filter media (310, 330, 350) (e.g., through the one or more air vents 312, 332, 352). All such variations are intended to fall within the scope of the present disclosure.

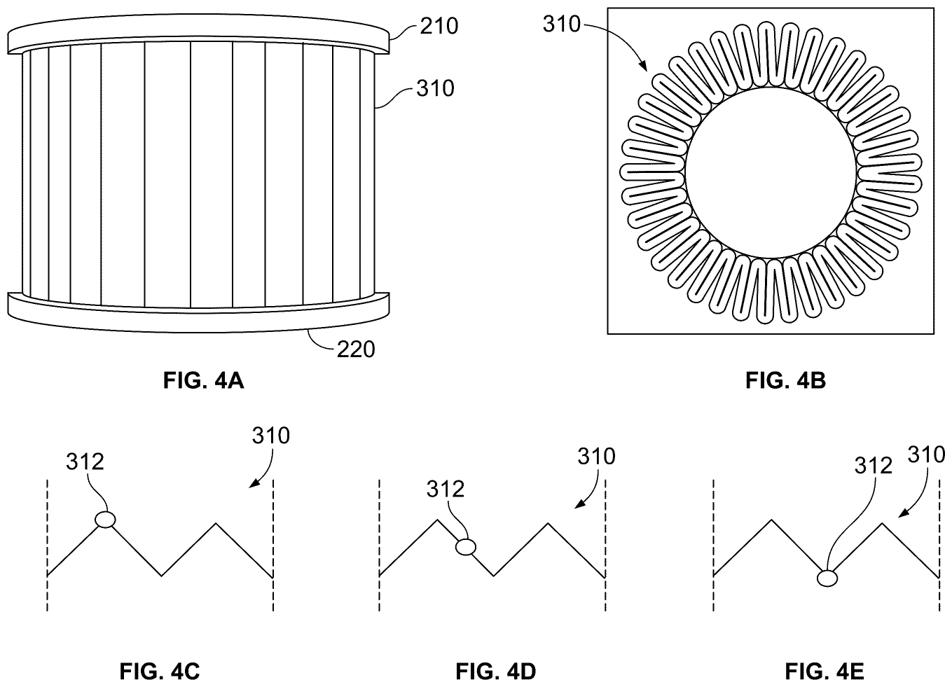

Now referring to FIGS. 4A-4E, various views of the first filter media 310 are shown according to various example embodiments. FIG. 4A is a side view of a filter media for the fuel water separator assembly 100 of FIG. 1A. As briefly described above, the first filter media 310 is a woven media, a non-woven media, or other suitable material that is pleated and wrapped in a cylindrical or annular configuration. The first filter media 310 is fixed between the first endplate 210 and the second endplate 220. As shown in FIG. 4B, the pleated configuration extends about the entire circumference of the first filter media 310. In the embodiment shown in FIG. 4C, the first air vent 312 is formed through an outer pleat tip (e.g., radially outward) of the first filter media 310. In the embodiment shown in FIG. 4D, the first air vent 312 is formed along a pleat face, between an outer pleat tip and an inner pleat tip, of the first filter media 310. In the embodiment shown in FIG. 4E, the first air vent 312 is formed through an inner pleat tip (e.g., radially inward) of the first filter media 310. The first air vent 312 is positioned at any of the positions shown in FIGS. 4C-4E based on, for example, a pleat density, a media type, a media material, and/or any other parameter related to the first filter media 310, and/or a corresponding manufacturing process.

Now referring to FIGS. 5A and 5B, various alternative and/or additional embodiments of the fuel water separator assembly 100 are shown. The embodiments shown in FIGS. 5A and 5B may be combined with each other and/or with any of the other embodiments described herein.

FIG. 5A is a side sectional view of a fuel water separator assembly 100, to an example embodiment. As shown, an unfiltered/unseparated fuel 400 enters the fuel water separator assembly 100 at the inlet 120. The fuel is filtered and water is separated by at least the first filter media 310. The water 410 is denser than fuel and flows to the bottom of the fuel water separator assembly 100. As described above, the filter media (310, 330, 350) includes air vents (312, 332, 352) for allowing air to pass therethrough. Contaminants may also pass through the air vents (312, 332, 352). The fuel water separator assembly 100 shown in FIG. 5A includes a fourth filter media 390 for further separating contaminants from the fuel. The fourth filter media 390 is a permanent coarse screen fixed to the fuel water separator assembly proximal the at least one outlet 124 and downstream the filter element 300. The fourth filter media 390 is substantially coarse (e.g., having large pores) and often has less media area than the filter media (310, 330, 350) upstream of the fourth filter media 390, such that the fourth filter media 390 has a higher face velocity. Due to the pore size and higher face velocity, the fourth filter media 390 substantially allows air to pass therethrough while trapping coarse contaminants that bypass the first filter media 310, the second filter media 350, and the third filter media 330. In an example embodiment, the fourth filter media 390 traps contaminants that pass through the air vents (e.g., air vents 312, 332, 352).

FIG. 5B is a top sectional view of a filter element 300, according to an example embodiment. As shown, the filter element 300 includes a plurality of third air vents 332 for allowing air to bypass the third filter media 330. The embodiment shown in FIG. 5B may be optionally included with any of the embodiments described herein. For example, the filter clement 300 may include the plurality of third air vents 332 when the gap 316 shown in FIG. 1C is not present between the first filter media 310 and the third filter media 330. In another example, the filter element may include the plurality of third air vents 332 when the gap 316 shown in FIG. 1C is present between the first filter media 310 and the third filter media 330. In some embodiments, the filter element 300 includes a plurality of first air vents 312 and/or a plurality of second air vents 352.

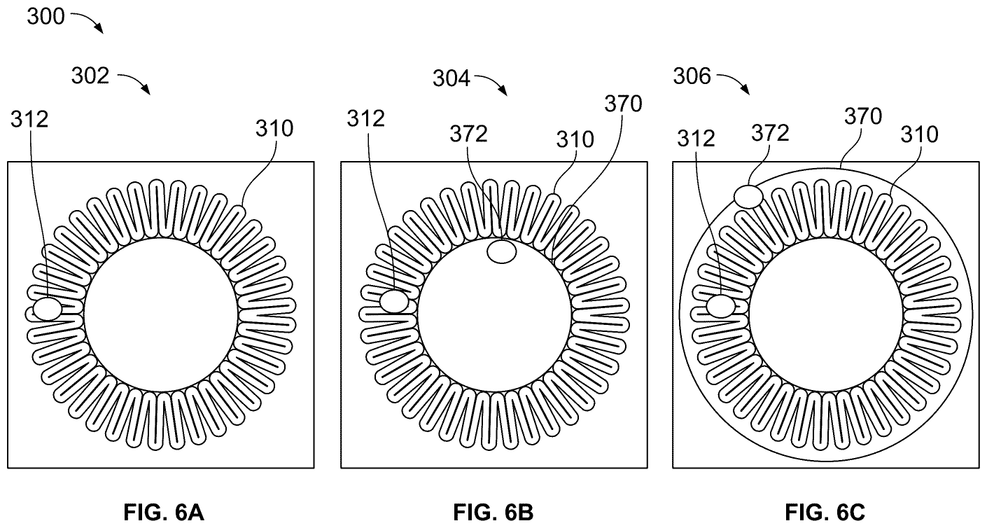

Now referring to FIGS. 6A-6C, top sectional views of various embodiments of filter elements 302, 304, 306 are shown. The filter elements 302, 304, 306 are configured to be used in various different types of a fuel water separator assembly.

FIG. 6A is a top sectional view of a filter element 302, for a first embodiment of a fuel water separator assembly 100. The filter element 302 includes a first filter media 310 and a first air vent 312 formed therethrough. The first filter media 310 is a woven mesh, non-woven material, or other suitable material filter media that is wrapped around in a substantially cylindrical shape and, in some embodiments, is pleated to increase surface area. In other embodiments, the first filter media 310 is a non-pleated depth media. The filter element 302 is configured to be used in a stripper or barrier type fuel water separator assembly. In the embodiment shown, the filter element 302 does not include a second filter media 350 or a third filter media 330.

FIG. 6B is a top sectional view of a filter element 304. The filter element 304 includes a first filter media 310 and second filter media 370. The first filter media 310, as described above, is a woven mesh, non-woven material, or other suitable material filter media that is wrapped around in a substantially cylindrical shape and pleated to increase surface area. The second filter media 370 is a coalescing media. The filter element 304 also includes a first air vent 312 formed through the first filter media and a second air vent 372 formed through the second filter media 370. The filter element 304 is configured to be used in an outside-in fuel water separator assembly.

FIG. 6C is a top sectional view of a filter element 306. The filter element 306 includes a first filter media 310 and second filter media 370 as described above with respect to FIG. 6B. As shown in FIG. 6C the second filter media 370 is positioned radially outward from the first filter media 310. The filter element 306 also includes a first air vent 312 formed through the first filter media and a second air vent 372 formed through the second filter media 370. The filter element 306 is configured to be used in an inside-out flow design for a fuel water separator assembly.

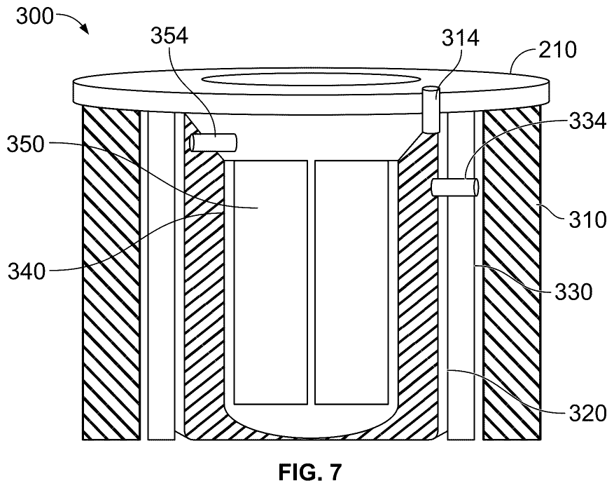

FIG. 7 is a side sectional view of a filter element 300, according to an example embodiment. As described above, the filter element 300 includes the first endplate 210, the first filter media 310, the center tube 320, the second filter media 350, the inner body 340, and the third filter media 330. In the embodiment shown in FIG. 7, the filter element 300 also includes a first air vent 314 formed through the first endplate 210. The first air vent 314 is structured to allow air to bypass the first filter media 310, such that the air is not trapped between an inlet of the fuel water separator assembly 100 and the first filter media 310. The first air vent 314 is also structured to allow air to bypass the third filter media 330. The first air vent 314 allows the air to flow from upstream of the first filter media 310 towards an outlet of the fuel water separator assembly 100. In the embodiment shown in FIG. 7, the first air vent 314 allows air to flow to an area downstream of the third filter media 330 and upstream of the second filter media 350. In other embodiments, the first air vent 314 allows the air to flow to an outlet of the fuel water separator assembly 100. In these embodiments, the first air vent 314 may be formed through the first sealing member 212 and/or through the first endplate 210 downstream of the second filter media 350. The filter element 300 also includes a third air vent 334 formed through the center tube 320. The third air vent 334 is structured to allow air to bypass the third filter media 330 such that the air is not trapped between the first filter media 310 and the third filter media 330. For example, the third air vent 334 is formed through a portion of the center tube 320 such that the air does not pass through the third filter media 330. The third air vent 334 allows the air to flow from an upstream side of the third filter media 330 to a downstream side of the third filter media 330. The third air vent 334 allows the air to flow downstream to the second filter media 350. The filter element 300 also includes a second air vent 354 formed through the inner body 340. The second air vent 354 is structured to allow air to bypass the second filter media 350 such that the air is not trapped between the third filter media 330 and the second filter media 350. For example, the second air vent 354 is formed through a portion of the inner body 340 such that the air does not pass through the second filter media 350. The second air vent 354 allows the air to flow from an upstream of the second filter media 350 to a downstream side of the second filter media 350. The second air vent 354 allows the air to flow downstream to an outlet of the fuel water separator assembly 100.

In additional embodiments, an area of one or more of the filter media (310, 330, 350, 370) is treated with an oleophobic treatment. For example, an area of the first filter media 310 is treated with an oleophobic treatment. The oleophobic treatment substantially prevents the fuel from wicking or wetting the first filter media 310 during priming of the fuel system. The area treated with the oleophobic treatment allows the air to pass through first filter media 310 as the system fills up with fuel. In these embodiments, the oleophobic treatment is provided instead of and/or in addition to the air vents (312, 314, 332, 334, 352, 354, 372).

In another embodiment, one or more of the air vents (312, 314, 332, 334, 352, 354, 372) is configured as a self-closing air vent. The self-closing air vent is configured to open in the presence of air at an inlet (e.g., upstream side) of the self-closing air vent and close in the presence of a liquid (e.g., fuel or water) at the inlet of the self-closing air vent. The function of the self-closing air vent is such that the air vent remains open in the presents of a gas (e.g., air), but when all of the gas is exhausted, liquid starts moving through the air vent, which increases drag force on the self-closing air vent, thereby closing the self-closing air vent. For example, the self-closing air vent closes due to an increase of drag force from a liquid relative to a gas (e.g., air). In an example embodiment, the first air vent 314, the second air vent 354, and/or the third air vent 334 is/are configured as a self-closing air vent.

In yet another embodiment, the filter element 300 includes a permeable media (not shown) that is disposed at an inlet side (e.g., upstream) of the first filter media 310. The permeable media is a woven screen or a non-woven scrim. The permeable media substantially prevents air from flowing downstream to the first filter media 310. In these embodiments, the filter element 300 may include one or more of the air vents (312, 314, 332, 334, 352, 354, 372) described herein. For example, the filter element may include the permeable media upstream of the first filter media 310 and the first air vent 314 such that air trapped upstream of the first filter media 310 and upstream of the permeable media may pass through the first air vent 314 to bypass the first filter media 310 and the third filter media 330.

In some embodiments, the fuel water separator assembly 100 includes a pump such as a jet pump, a venturi pump, or any other mechanism for drawing suction sufficient to remove gas from the filter head 110 and/or the filter cartridge 130. In the case of the jet pump, venturi pump, or similar pump configuration, the pump is driven by pressurized fluid passing through it which, due to the geometry of the pump, causes suction to be developed at a pump suction port. The pump causes suction at an inlet side (e.g., upstream) of the permeable media. For example, the inlet of the pump is positioned at a top portion of the filter element 300 (e.g., where air rises to the top of the filter element 300) and away from a high fuel flow area of the filter element 300. In some embodiments, the filter element 300 further includes one or more passages to connect an inlet side of each filter media (310, 330, 350) to the pump. In these embodiments, each passage is fluidly sealed by a gasket such that fuel cannot bypass the filter media via the passages. In additional and/or alternative embodiments, other sources of vacuum may be connected to the filter housing such that they extract air from an upstream side of each media layer. In these embodiments, the filter clement 300 may include the permeable media.

In some embodiment, the air vents (312, 314, 332, 334, 352, 354, 372) are sized to substantially allow air to pass therethrough while limiting the amount of liquid to pass therethrough and bypassing the filter media (310, 330, 350, 370). In some embodiments, the air vents (312, 314, 332, 334, 352, 354, 372) are approximately 1.1 millimeters (mm) in diameter. In some embodiments, the air vents (312, 314, 332, 334, 352, 354, 372) size may range from 0.5 mm to 1.5 mm in diameter, 0.1 mm to 3 mm in diameter, or 0.5 mm to 1 mm in diameter. In other embodiments, the air vents are smaller than 0.1 mm or larger than 3 mm in diameter. According to various example embodiments, the air vents (312, 314, 332, 334, 352, 354, 372) are each sized relative to the pores of the filter media (310, 330, 350, 370) each of the air vents (312, 314, 332, 334, 352, 354, 372) is formed through, such that the air vents (312, 314, 332, 334, 352, 354, 372) are larger in diameter than the pores of the filter media (310, 330, 350, 370). In these embodiments, the air vents (312, 314, 332, 334, 352, 354, 372) may also be sized based on the change in pressure across the filter media (310, 330, 350, 370) through which each of the air vents (312, 314, 332, 334, 352, 354, 372) is formed such that air may pass through from a high pressure side to a low pressure side. In yet other embodiments, the air vents (312, 314, 332, 334, 352, 354, 372) are sized large enough such that the air vents (312, 314, 332, 334, 352, 354, 372) are not easily plugged by foreign materials and small enough such that the air vents (312, 314, 332, 334, 352, 354, 372) limit fluid from bypassing the filter media (310, 330, 350, 370).

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “approximately” and similar terms are intended to have a broad meaning in harmony with the common and accepted usage by those of ordinary skill in the art to which the subject matter of this disclosure pertains. The term “approximately” as used herein refers to +10% of the referenced measurement, position, or dimension. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A filter cartridge comprising:
a filter element comprising:
a first filter media structured to filter fuel; and
a second filter media positioned downstream the first filter media and structured to filter the fuel;
a first vent positioned at a filter element first end and structured to allow air to pass therethrough; and
a second vent positioned at the filter element first end and downstream of the first vent, the second vent structured to allow the air to pass therethrough.

2. The filter cartridge of claim 1, wherein the first vent is formed through the first filter media such that the first vent allows the air to bypass the first filter media.

3. The filter cartridge of claim 1, wherein the second vent is formed through the second filter media such that the second vent allows the air to bypass the second filter media.

4. The filter cartridge of claim 1, further comprising:
a first endplate coupled to a first filter media first end; and
an inner body coupled to the second filter media.

5. The filter cartridge of claim 4, wherein the first vent is formed through the first endplate such that the first vent allows the air to pass through the first endplate.

6. The filter cartridge of claim 4, wherein the second vent is formed through the inner body such that the second vent allows the air to pass through the inner body.

7. The filter cartridge of claim 1, further comprising:
a third filter media positioned downstream the first filter media and upstream the second filter media and structured to filter the fuel; and
a third vent positioned at the filter element first end and structured to allow the air to pass therethrough.

8. The filter cartridge of claim 7, wherein the third vent is formed through the third filter media such that the third vent allows the air to bypass the third filter media.

9. The filter cartridge of claim 7, wherein the first filter media and the third filter media are separated by a gap.

10. The filter cartridge of claim 7, further comprising a center tube positioned upstream or downstream of the third filter media.

11. The filter cartridge of claim 10, wherein the third vent is formed through the center tube such that the third vent allows the air to pass through the center tube.

12. The filter cartridge of claim 1, wherein the second filter media is a perforated layer coalescer.

13. The filter cartridge of claim 7, further comprising a permeable media disposed at an inlet side of the first filter media, wherein the permeable media is at least one of a woven screen or a non-woven scrim.

14. A filtration system comprising:
a filter head comprising an inlet for receiving a fuel and an outlet for providing filtered fuel;
a filter cartridge coupled to the filter head, the filter cartridge comprising:
a filter element comprising a first filter media structured to filter the fuel; and
a first vent positioned at a filter element first end and structured to allow air to pass therethrough; and
wherein the outlet is positioned at a suction side of a pump.

15. The filtration system of claim 14, wherein the first vent is formed through the first filter media such that the first vent allows the air to bypass the first filter media.

16. The filtration system of claim 14, wherein the filter element comprises a second filter media positioned downstream the first filter media and structured to filter the fuel.

17. The filtration system of claim 16, wherein the filter cartridge comprises a second vent positioned at the filter element first end and structured to allow the air to pass therethrough.

18. The filtration system of claim 17, wherein the second vent formed through the second filter media such that the second vent allows the air to bypass the second filter media.

19. The filtration system of claim 17, further comprising:
a first endplate coupled to a first filter media first end; and
an inner body coupled to the second filter media.

20. The filtration system of claim 19, wherein the first vent is formed through the first endplate such that the first vent allows the air to pass through the first endplate.

21. The filtration system of claim 19, wherein the second vent is formed through the inner body such that the second vent allows the air to pass through the inner body.

22. The filtration system of claim 17, wherein the filter element further comprises a third filter media positioned downstream the first filter media and upstream the second filter media and structured to filter the fuel; and
wherein the filter cartridge further comprises a third vent positioned at the filter element first end and structured to allow the air to pass therethrough.

23. The filtration system of claim 22, wherein the first filter media and the third filter media are separated by a gap.

24. The filtration system of claim 22, wherein the third vent is formed through the third filter media such that the third vent allows the air to bypass the third filter media.

25. The filtration system of claim 22, further comprising a center tube positioned upstream or downstream of the third filter media.

26. The filtration system of claim 25, wherein the third vent is formed through the center tube such that the third vent allows the air to pass through the center tube.

27. A filter element comprising:
a first filter media structured to filter fuel;
a second filter media positioned downstream of the first filter media and structured to filter the fuel;
a first endplate coupled to the first filter media, the first endplate having a first vent formed therethrough, the first vent enabling a fluid to flow from an upstream side of the first filter media to an upstream side of the second filter media thereby bypassing the first filter media; and
an inner body coupled to the first endplate and coupled to the second filter media, the inner body having a second vent formed therethrough, the second vent enabling the fluid to bypass the second filter media.

28. The filter element of claim 27, further comprising a third filter media positioned between the first filter media and the second filter media, wherein the first vent enables the fluid to flow from the upstream side of the first filter media to a downstream side of the third filter media thereby bypassing the first filter media and the third filter media.

29. The filter element of claim 28. further comprising a center tube surrounded by the third filter media, the center tube including a third air vent formed therethrough, the third air vent enabling the fluid to bypass the third filter media.
